(19) United States
(12) Patent Application Publication
(10) Pub. No.: US 2026/0163392 A1
(43) Pub. Date: Jun. 11, 2026

(54) Connection apparatus for a rechargeable battery

(71) Applicant: Hilti Aktiengesellschaft, Schaan (LI)

(72) Inventors: Markus HARTMANN, Mauerstetten (DE); Markus HOLUBARSCH, Landsberg am Lech (DE); Henrik WALTER, Kaufering (DE)

(21) Appl. No.: 18/707,729

(22) PCT Filed: Dec. 1, 2022
(86) PCT No.: PCT/EP2022/084017

§ 371 Date: May 6, 2024

(30) Foreign Application Priority Data
Dec. 1, 2021 (EP) 21211583.6
Dec. 1, 2021 (EP) 21211587.7
Dec. 1, 2021 (EP) 21211593.5

(51) Int. Cl. H02J 7/70; H01R 13/11; H01R 24/68

(52) U.S. Cl. CPC H02J 7/751; H01R 13/112; H01R 24/68; H02J 7/731

(57) ABSTRACT

A battery connection apparatus on a rechargeable battery, in particular as power supply for a power tool, for releasably connecting the rechargeable battery to the power tool. The battery connection apparatus contains an outer frame and an inner frame, wherein the inner frame contains at least a first and second contact element and the outer frame contains a guide device for guiding an inner frame in at least one direction/plane, wherein the inner frame is positioned by at least one elastic element in a force-loaded manner at least in part in the guide device.

The present invention relates to a battery connection apparatus on a rechargeable battery, in particular as power supply for a power tool, for releasably connecting the rechargeable battery to the power tool.

The present invention also relates to a power tool connection apparatus on a power tool for releasably connecting the power tool to a rechargeable battery, wherein the rechargeable battery serves in particular as power supply for the power tool.

The present invention furthermore relates to a system formed of a power tool connection apparatus on a power tool and a battery connection apparatus on a rechargeable battery, in particular as releasable power supply for the power tool, wherein the battery connection apparatus contains at least a first and second contact element and the power tool connection apparatus contains at least a first and second mating contact element for releasable connection to each of the first and second contact element.

### BACKGROUND

Rechargeable batteries (also referred to as batteries) are largely known in accordance with the prior art as power supply for a power tool. These rechargeable batteries usually contain a number of energy storage cells (also referred to as battery cells), which serve and are designed to receive, store and deliver electrical energy. The take-up of electrical energy into the energy storage cells can also be referred to as charging (or loading). The delivery of electrical energy from the energy storage cells can also be referred to as discharging.

For loading or charging with electrical energy, the rechargeable battery is usually connected to a charging apparatus (also called a charger). The charging apparatus conducts electrical energy in accordance with a predetermined charging setting (also called the charging mode) having defined parameters for the actual charging process at the individual energy storage cells of the rechargeable battery.

Cordless power tools can be operated with one or more rechargeable batteries for the purpose of supplying power. The rechargeable battery is removable here from the power tool in order to be able to charged again with electrical energy in a charging apparatus.

In an assembled state, i.e. when the power tool and the rechargeable battery are connected to one another, the electrical energy is transferred from the rechargeable battery to the power tool by means of electrical contact partners. The contact partners consist here of a first and second contact element which are connectable to one another. The first electrical contact element is arranged on the rechargeable battery and the second contact element is arranged on the power tool. The second contact element is usually pushed into the first contact element. The second contact element can also be referred to as a receiving element, since it is suitable, amongst other things, for receiving electrical energy for the power tool.

### SUMMARY OF THE INVENTION

During operation of the power tool, the electrical contact elements may be exposed to a high mechanical load in the form of acceleration forces due to application-related vibrations or oscillations. Besides this mechanical load, an electrical load in the form of electrical current may also be applied.

This mechanical load can lead to relative movements between the contact elements on the power tool and on the battery, thus causing wear to the contact elements. Depending on the application of the power tool, this wear may additionally also be intensified by an infiltration of dust between the contact elements. Due to the vibration-induced relative movement between the contact elements and due to a wear-induced increase of the contact resistance of the contact elements, the contact elements may be thermally overloaded, which may even lead to burnout of the contact elements.

An object of the present invention is therefore to solve the problem described above.

The present invention provides a battery connection apparatus on a rechargeable battery, in particular as power supply for a power tool, for releasably connecting the rechargeable battery to the power tool.

It is provided in accordance with the invention that the battery connection apparatus contains an outer frame and an inner frame, wherein the inner frame contains at least a first and second contact element and also a first insertion and holding device, and wherein the inner frame is positionable by at least one elastic element in a force-loaded manner in at least one direction. It is hereby ensured in a simple way that the inner frame with the contact elements is located in a predetermined orientation which is virtually optimal for connection to mating contacts of a power tool.

In accordance with an advantageous embodiment, it may be possible that the outer frame contains a second insertion and holding device.

In accordance with a further advantageous embodiment, it may be possible that the outer frame contains a guide device for receiving and releasably holding at least a partial region of the inner frame in at least one direction.

In accordance with a further advantageous embodiment, it may be possible that the first insertion and holding device contains at least a first and second cutout and the second insertion and holding device contains at least a third and fourth cutout.

In addition, the present invention provides a power tool connection apparatus on a power tool for releasably connecting the power tool to a rechargeable battery, wherein the rechargeable battery serves in particular as power supply for the power tool.

It is provided in accordance with the invention that the power tool connection apparatus contains an outer frame and an inner frame, wherein the inner frame contains at least a first and second contact element and also a first insertion and holding device, wherein the inner frame is positionable by at least one elastic element, force-loaded in at least one direction.

In accordance with an advantageous embodiment, it may be possible that the outer frame contains a second insertion and holding device.

In accordance with a further advantageous embodiment, it may be possible that the outer frame contains a guide device for receiving and releasably holding at least a partial region of the inner frame in at least one direction.

In accordance with a further advantageous embodiment, it may be possible that the first insertion and holding device contains at least a first and second cutout and the second insertion and holding device contains at least a third and fourth cutout.

Furthermore, the present invention provides a system formed of a power tool connection apparatus on a power tool and a battery connection apparatus on a rechargeable battery, in particular as releasable power supply for the power tool, wherein the battery connection apparatus contains at least a first and second contact element and the power tool connection apparatus contains at least a first and second mating contact element for releasable connection to each of the first and second contact element.

It is provided in accordance with the invention that the battery connection apparatus or the power tool connection apparatus contains an outer frame and an inner frame, wherein the inner frame is positionable by at least one elastic element, force-loaded in at least one direction, and wherein the inner frame contains the at least first and second contact element and also a first insertion and holding device for inserting and releasably holding at least a portion of the at least first and second mating contact element in the inner frame or the inner frame contains the at least first and second mating contact element and also a first insertion and holding device for inserting and releasably holding at least a portion of the at least first and second contact element in the inner frame.

In accordance with an advantageous embodiment, it may be possible that the outer frame contains a second insertion and holding device for inserting and releasably holding at least a portion of the at least first and second contact element or at least a portion of the at least first and second mating contact element.

In accordance with a further advantageous embodiment, it may be possible that the first insertion and holding device contains at least a first and second cutout and the second insertion and holding device contains at least a third and fourth cutout.

In accordance with a further advantageous embodiment it may be possible that the power tool connection apparatus contains a receiving region for receiving and releasably holding the battery connection apparatus, wherein the receiving region has a first length and the outer frame has a second length, and wherein the first length is equal to or greater than the second length, and wherein each cutout of the insertion device has a first width and each cutout of the holding device has a second width, and wherein the first width is equal to or greater than the second width, and wherein a difference between the first width and the second width is equal to or smaller than a difference between the first length and the second length.

In accordance with a further advantageous embodiment, it may be possible that the outer frame contains a guide device for receiving and releasably holding at least a partial region of the inner frame in at least one direction.

### BRIEF DESCRIPTION OF THE DRAWINGS

Further advantages will become apparent from the following description of the figures. A particularly preferred exemplary embodiment of the present invention is depicted in the figure. The figures, the description and the claims contain numerous features in combination. A person skilled in the art will expediently also consider the features individually and combine them to form useful further combinations.

Identical and similar components are denoted by the same reference signs in the figure,
in which:

FIG. 1 shows a side view of a power tool with a power tool connection apparatus together with a rechargeable battery with a battery connection apparatus;

FIG. 2 shows a side view of the rechargeable battery with the battery connection apparatus;

FIG. 3 shows a perspective view of the battery connection apparatus and a power tool connection apparatus according to a first exemplary embodiment in a non-connected state;

FIG. 4 shows a plan view of the battery connection apparatus and the power tool connection apparatus in a state brought closer to one another;

FIG. 5 shows a plan view of the battery connection apparatus and the power too connection apparatus in a connected state; and

FIG. 6 shows a plan view of the battery connection apparatus and the power tool connection apparatus according to a further exemplary embodiment in a connected state.

### DETAILED DESCRIPTION

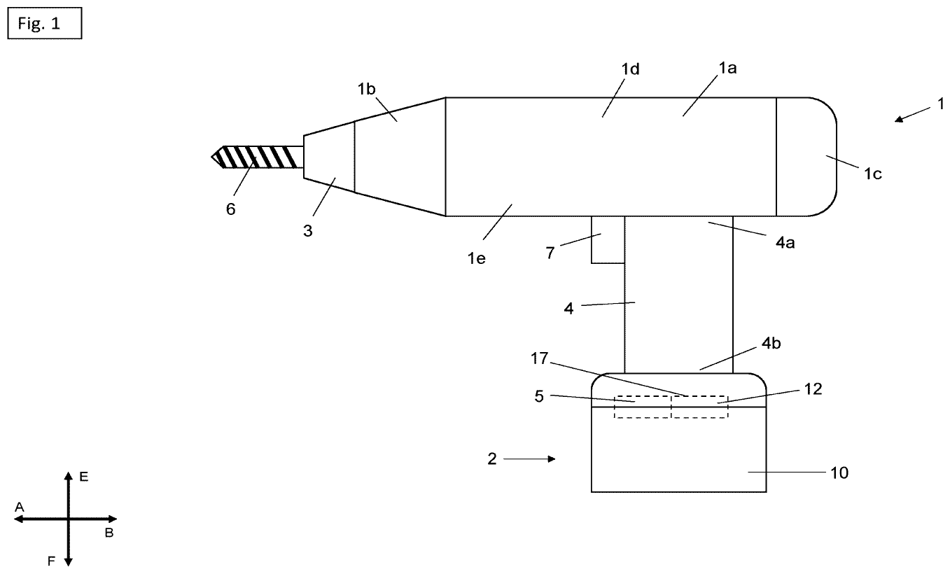

FIG. 1 shows a power tool 1 with a rechargeable battery 2.

The power tool 1 is embodied in the figures as a power drill and contains fundamentally a power tool housing 1a, a tool holder 3, a handle 4 and a power tool connection apparatus 5.

The power tool housing 1a has a front end 1b, a rear end 1c, a top side 1d and an underside 1e.

The tool holder 3 serves to receive and hold a tool 6 and is, as shown in FIG. 1, arranged at the front end 2a of the power tool housing 2. In the present exemplary embodiment, the tool 6 is embodied as a drill.

A drive, a control apparatus, a gear apparatus and an output shaft are provided inside the power tool housing 2. The drive is embodied in the form of a brushless electric motor and serves for generating a torque. The tool holder, the output shaft, the gear apparatus and the drive embodied as an electric motor are arranged relative to one another such that the torque generated by the drive can be transmitted to the tool 6 via the gear apparatus, the output shaft and the tool holder 3.

The control apparatus serves to control the functions of the power tool 1 and in particular of the drive in an open-loop and closed-loop manner. The functions include, amongst other things, the setting of the drive speed.

The handle 4 serves to hold and guide the power tool 1 and contains a first end 4a, by means of which the handle 4 is arranged on the underside 2d of the power tool housing 2. An activation switch 7 is provided on a front side of the handle 4 and is used to bring the power tool 1 into an activation mode. The power tool connection apparatus 5 is positioned at a second end 4b and serves to receive and hold and also electrically connect the power tool to the rechargeable battery 2.

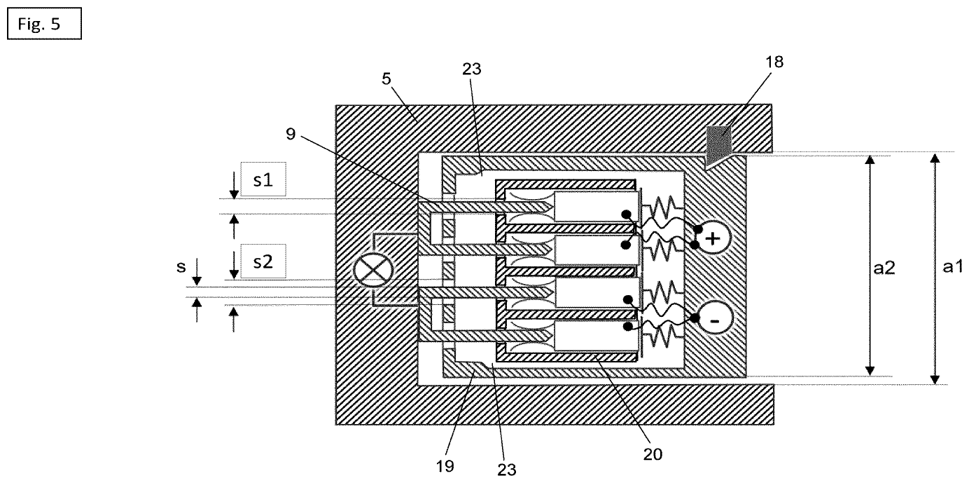

The power tool connection apparatus 5 contains fundamentally a receiving region 8 embodied as a cutout, with a first length a1 and also four adjacently arranged mating contact elements 9. Each mating contact element 9 has a width S, which relates to an extent in the direction C-D (see, e.g., FIG. 5).

The length a1 of the receiving region 8 relates to an extent in direction C-D. The mating contact elements 9 are two positive mating contacts and also two negative mating contacts and serve to generate an electrical circuit with the consumers (i.e., for example the drive) when the rechargeable battery 2 is connected as power source to the power tool connection apparatus 5.

As likewise shown in the figures, each mating contact element 9 is embodied in the form of a contact pin (also called a contact blade). The mating contact element 9 may in this case also be referred to as a plug.

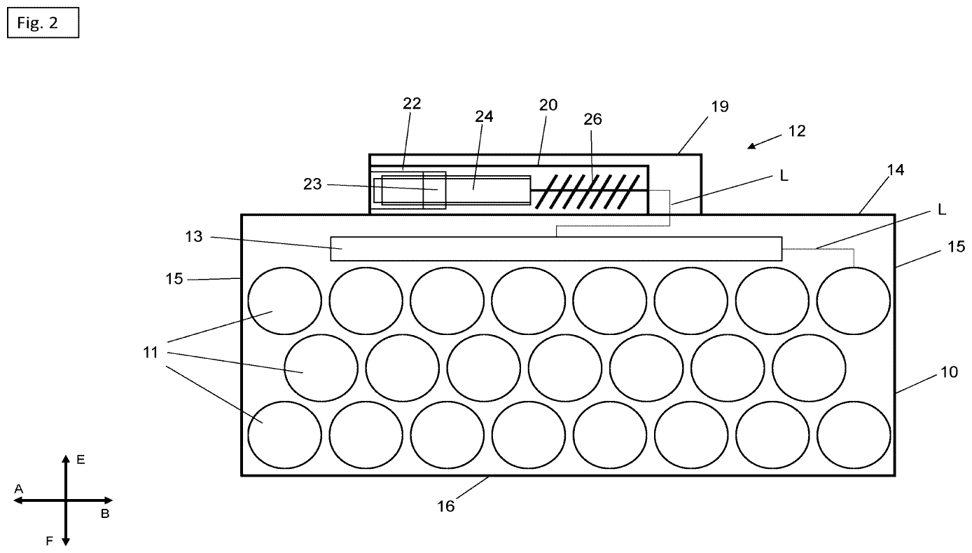

The rechargeable battery 2 fundamentally contains here a battery housing 10, a number of energy storage cells 11, a battery connection apparatus 12 and a control device 13; cf. FIG. 2. The energy storage cells 11 can also be referred to as battery cells.

The battery housing 10 fundamentally contains here a cover element 14, four side walls 15, and a base element 16.

The battery connection apparatus 12 serves for electrically or electronically connecting the rechargeable battery 2 to the power tool 1.

The energy storage cells 11 serve to receive, store and re-deliver electrical energy. As indicated in the figures, the energy storage cells 11 are cylindrical and embodied on the basis of lithium-ion technology. Each energy storage cell 11 contains, at one end, a contact device which serves for the transmission of electrical energy. The individual contact devices are connected to the control device via corresponding lines L (see, e.g., FIG. 2).

Alternatively, the energy storage cells 11 are also based on another suitable technology.

The cylindrical form of the energy storage cells 11 is likewise optional, so that any other suitable form or geometry can also be selected. For example, it is in particular also possible that the energy storage cells 11 are embodied as pouch cells.

It is additionally also possible that the rechargeable battery 2 contains both cylindrical energy storage cells 11 and pouch cells. It is possible in particular that the rechargeable battery 2 contains a single cylindrical energy storage cell and a single pouch cell.

The control device 13 is used to control the different functions of the rechargeable battery 2 in a closed-loop and open-loop manner. In addition, the control device 13 is connected to the energy storage cells 11 and the battery connection apparatus 12 via corresponding lines L such that electrical energy can pass from the energy storage cells 11 via the control device 13 to the battery connection apparatus 12.

To releasably mechanically couple the rechargeable battery 2 to the power tool 1, a rail apparatus 17 is provided (shown schematically in FIG. 1.

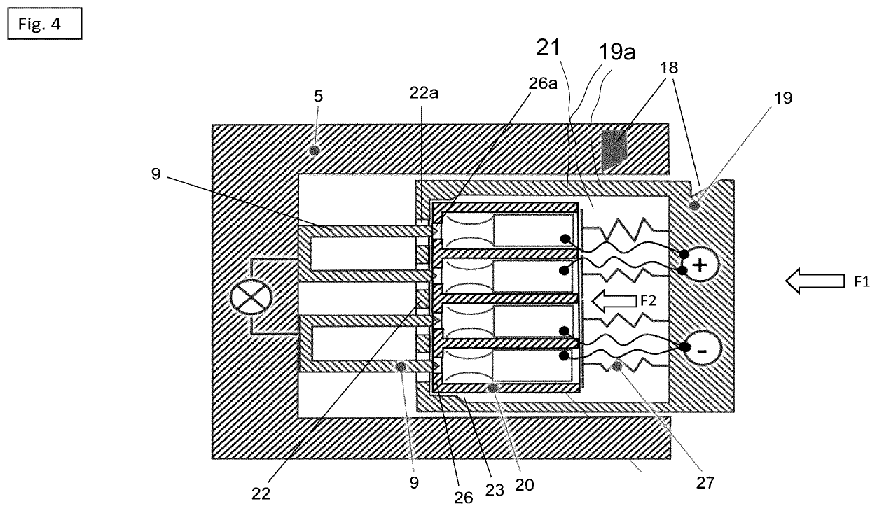

A locking apparatus 18 serves for releasably connecting the rechargeable battery 2 to the power tool 1 (see, e.g., FIG. 4).

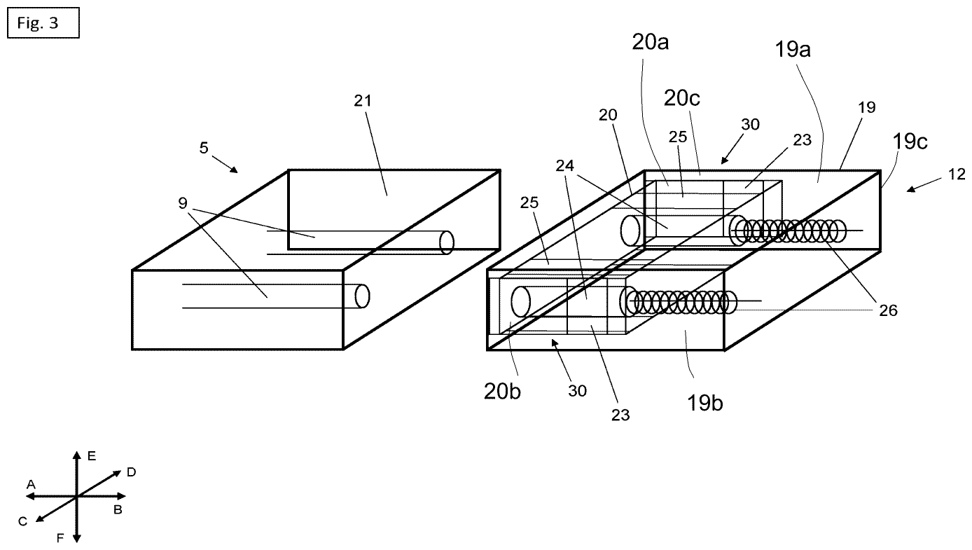

Furthermore, the battery connection apparatus 12 contains an outer frame 19 and an inner frame 20 positioned in the outer frame 19; cf. FIGS. 3 to 6.

The outer frame 19 has a cavity 21 which is open to one side and in which the inner frame 20 is positioned. In addition, the outer frame 19 has substantially four side walls 19a, a base element 19b, and a cover element 19c. (see, e.g., FIG. 3) FIGS. 4 to 6 do not show the base element 19b or a cover element 19c.

Furthermore, an insertion device 22 with four adjacently arranged cutouts 22a is contained on a first side wall 19a. The insertion device 22 serves to orient or precisely position the outer frame 19 relative to the mating contact elements 9. Each cutout 22a has a width s1, which relates to an extent in direction C-D. The width s1 is greater here than the width S of a mating contact element 9, so that a mating contact element 9 has a certain clearance fit in the cutout 22a of the outer frame 19.

The outer frame 19 has a second length a2. The length a2 of the outer frame 19 relates to an extent in direction C-D. The first length a1 is slightly greater than the second length a2, so that the outer frame 19 can be introduced with slight play or a clearance fit in the receiving region 8. (see, e.g., FIG. 5).

The outer width, length and width of the inner frame 20 is smaller here than the corresponding width, length and height of the cavity 21 of the outer frame 19. In other words, the volume of the inner frame 20 is smaller on the whole in all three dimensions (x-y-z) or in the corresponding extents in A-B direction, CD direction and E-F direction than the volume of the cavity 21 of the outer frame 19. The inner frame 20 can hereby move in the directions A-B, C-D and E-F in the cavity 21 of the outer frame 19. In addition, a guide device 30 for receiving and guiding a front portion of the inner frame 20 is contained towards the open side of the cavity 21. (see, e. g, FIG. 3). The width of the guide device 30 corresponds here substantially to the outer width of the inner frame 20, so that the inner frame 20 can be introduced with an accurate fit into the guide device 30. The guide device 30 and also the inner frame 20 are embodied here such that the inner frame 20 can be guided in merely one direction (i.e., in direction A or B) or plane when the front portion of the inner frame 20 is in the guide device 30.

In the present exemplary embodiment, the guide device 30 is embodied as a cutout 23 running in direction A and on both sides from the open side of the cavity 21. The cutout 23 can also be referred to as a step or graduation. In direction A, a slope that tapers or runs to a point in a funnel-shaped manner is provided in front of the cutout 23 embodied as a step. The slope serves as an insertion aid for the front portion of the inner frame 20 into the cutout 23.

The inner frame 20 contains fundamentally four side walls 20a, a base element 20b and a cover element 20c as well as a number of contact elements 24. FIGS. 4 to 6 do not show the base element 20b or cover element 20c. In accordance with a first exemplary embodiment shown in the figures, four contact elements 24 are provided on the inner frame 20. Alternatively, more or fewer than four contact elements 24 may also be contained. The four contact elements 24 are each two positive contacts and two negative contacts. The inner frame 20 has, on a front side, four cutouts 25, in which there are arranged the four contact elements 24 such that a receiving region of each contact plug 24 protrudes from the cutout 25 of the inner frame 20 in direction A.

Each positive contact and negative contact is embodied in the form of a contact socket. The contact elements 24 serve for releasable connection to the mating contact elements 9 of the power tool connection apparatus 5; for this purpose, the mating contact elements 9 embodies as plugs are plugged into the contact elements 24 embodied as sockets.

On a side wall of the inner frame 20 embodied as a front side there is container a holding device 26 with four cutouts 26a arranged adjacently to one another. The holding device 26 serves to receive and hold the mating contact elements 9 in the contact elements 24.

Each cutout 26a has a width s2, which relates to an extent in direction C-D. (see, e. g, FIG. 5). The width s2 is greater here than the width S of a mating contact element 9, so that a mating contact element 9 has a certain clearance fit in the cutout 26a of the outer frame 20. At the same time, the width s2 is smaller than the width s1 of a cutout 22a of the outer frame 19.

Alternatively, an elastic element with an opening can be contained on each cutout 26a, said elastic elements being embodied such that the width s2 of the cutout 26a is smaller than the width S of a mating contact element 9. If, however, a mating contact element 9 is introduced into this cutout 26a with an elastic element, the elastic element widens around the cutout 26a to the width S of the mating contact element 9. With the aid of the elastic element, the cutout 26a can generally be kept small and the infiltration of dirt can be reduced.

A first and second elastic element 27 in the form of a spiral spring are arranged on a side wall 20a of the inner frame 20 embodied as a rear side. (see e.g., FIG. 4). Each elastic element 27 is positioned here between the inner frame 20 and outer frame 19 such that a first end of an elastic element 27 is fastened to the outer rear side of the inner frame 20 and a second end of an elastic element 27 is fastened to an inner rear wall of the outer frame 19. With the aid of the spring force of the elastic elements 27, the inner frame 20 is pushed in direction A such that the front portion of the inner frame 20 (as described above) is pushed into the guide device 30. In a state loaded on one side, i.e., if merely the elastic elements 27 push the inner frame 20 in direction A, the free ends of the four contact elements 24 are located in direction B behind a plane towards the free end of the outer frame 19; cf. FIGS. 3 to 6.

To actually connect the battery connection apparatus 12 to the power tool connection apparatus 5, a force F1 is exerted on the outer frame 19 in direction A by a user in order to move the battery connection apparatus 12 in the direction A and towards the mating contact elements 9 of the power tool connection apparatus 5; cf. FIG. 4. The two elastic elements 27 exert a spring force F2 likewise in direction A onto the inner frame 20, so that the inner frame 20 is pushed in direction A and the front portion of the inner frame 20 is guided and held in the guide device 30.

The force F1 applied by the user is used so that ultimately the contact elements 24 and the mating contact elements 9 are brought into connection. For this purpose, each mating contact element 9 embodied as a blade is firstly pushed through the corresponding cutout 22a of the insertion device 22 of the outer frame 19, the corresponding cutout 26a of the holding device 26 of the inner frame 20 and into the contact element 24 embodied as a socket. Furthermore, due to the exertion of force by the user, the inner frame is likewise moved in direction B and fully out of the guide device 30 if the force F1 exerted by the user is greater than the spring force F2 generated by the elastic elements. Since the inner frame 20 is now released from the guide device 30 and is in the cavity 21 of the outer frame 19, the inner frame 20 can move together with the contact elements 24, which are connected to the mating contact elements 9, in the directions A-B, C-D and E-F within the cavity 21 of the outer frame 19. Merely the elastic elements 27 hold the inner frame 20 when the inner frame 20 moves in three dimensions (x-y-z) in the cavity 21 of the outer frame 19.

In accordance with an alternative embodiment, instead of the battery connection apparatus 12, the power tool connection apparatus 5 can also have an outer frame and inner frame as described above. As also in the above-described exemplary embodiment with the battery connection apparatus 12, the inner frame 20 contains four contact elements 24 and the outer frame 19 contains a guide device 30 for guiding an inner frame 20 in at least one direction A. The inner frame 20 is likewise positioned by two elastic elements 27 (for example compression springs) in a force-loaded manner in the guide device 30, at least in part.

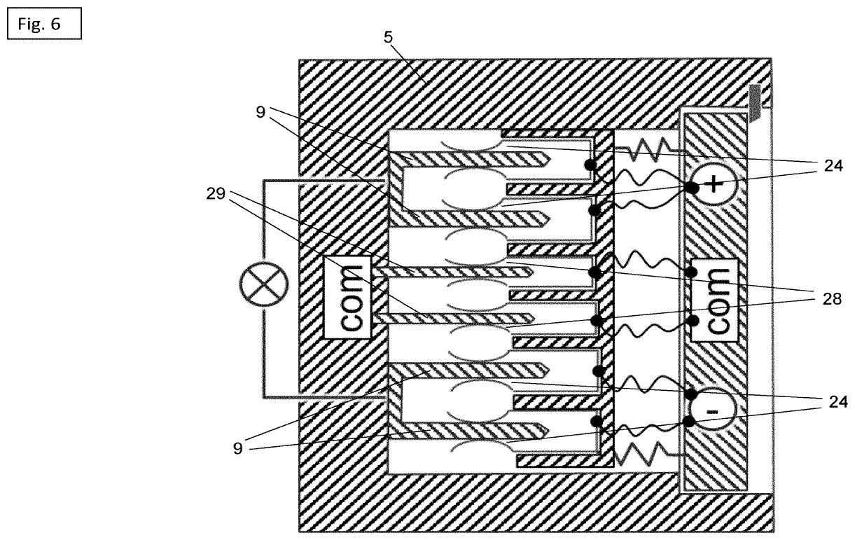

FIG. 6 shows a further embodiment of the battery connection apparatus 12 and of the power tool connection apparatus 5. This further embodiment of the battery connection apparatus 12 and power tool connection apparatus 5 corresponds here substantially to the exemplary embodiment of the battery connection apparatus 12 and power tool connection apparatus described above and with reference to FIGS. 3 to 6. In the further embodiment of the battery connection apparatus 12 and power tool connection apparatus 5, however, the battery connection apparatus 12 additionally has two communication contacts 28 and the power tool connection apparatus 5 additionally has two communication mating contacts 29.

As can be seen in FIG. 6, the two communication contacts are positioned between the contact elements 24 of the battery connection apparatus 12 embodied as positive and negative contacts. Furthermore, the two communication mating contacts are positioned between the mating contact elements 9 of the battery connection apparatus 5 embodied as positive and negative contacts.

If the communication contacts 28 and communication mating contacts 29 are connected, data and information can be exchanged in the form of electrical signals between the rechargeable battery 2 and the power tool 1.

### List of Reference Signs

1 Power tool
2 Rechargeable battery
1a Power tool housing
1b Front end of the power tool housing
1c back end of the power tool housing
1d Top side of the power tool housing
1e Underside of the power tool housing
3 Tool fitting
4 Handle
4a First end of the handle
4b Second end of the handle
5 Power tool connection apparatus
6 Tool
7 Activation switch
8 Receiving region
9 Mating contact element
10 Battery housing
11 Energy storage cells
12 Battery connection apparatus
13 Control device
14 Cover element of the battery housing four 15 and one 16
15 Side wall of the battery housing
16 Base element of the battery housing
17 Rail apparatus
18 Locking apparatus
19 Outer frame
20 Inner frame
21 Cavity
22 Insertion device
22a Cutout of the insertion device
23 Cutout
24 Contact element
25 Cutout on the inner frame
26 Holding device
26a Cutout on the holding device
27 Elastic element
28 Communication contact
29 Communication mating contact
30 Guide device
F1 First force
F2 Second force
L Line
S Width of the mating contact element
s1 Width of a cutout of the insertion device
s2 Width of a cutout of the holding device

What is claimed is:

1-13. (canceled)

14. A battery connection apparatus on a rechargeable battery for releasably connecting the rechargeable battery to a power tool, the battery connection apparatus comprising:
an outer frame; and
an inner frame, the inner frame including first and second contacts and a holding device, the inner frame being positionable by at least one elastic element in a force-loaded manner in at least one direction.

15. The battery connection apparatus as recited in claim 14 wherein the outer frame includes an insertion device.

16. The battery connection apparatus as recited in claim 14 wherein the outer frame includes a guide for receiving and releasably holding at least a partial region of the inner frame in the at least one direction.

17. The battery connection apparatus as recited in claim 14 wherein the insertion device includes a first and second cutout and the holding device includes a third and fourth cutout.

18. The battery connection apparatus as recited in claim 14 wherein the rechargeable battery is a power supply for the power tool.

19. A power tool connection apparatus on a power tool for releasably connecting the power tool to a rechargeable battery, the power tool connection apparatus comprising:
an outer frame; and
an inner frame, the inner frame including first and second contacts and a holding device, the inner frame being positionable by at least one elastic element in a force-loaded manner in at least one direction.

20. The power tool connection apparatus as recited in claim 19 wherein the outer frame includes an insertion device.

21. The power tool connection apparatus as recited in claim 19 wherein the outer frame includes a guide for receiving and releasably holding at least a partial region of the inner frame in the at least one direction.

22. The power tool connection apparatus as recited in claim 19 wherein the insertion device includes a first and second cutout and the holding device includes a third and fourth cutout.

23. The power tool connection apparatus as recited in claim 19 wherein the rechargeable battery is a power supply for the power tool.

24. A system comprising:
a power tool connection apparatus on a power tool; and
a battery connection apparatus on a rechargeable battery, the battery connection apparatus including first and second contacts and the power tool connection apparatus including first and second mating contacts for releasable connection to each of the first and second contacts, the battery connection apparatus or the power tool connection apparatus including an outer frame and an inner frame, the inner frame being positionable by at least one elastic element in a force-loaded manner in at least one direction, and wherein the inner frame includes first and second contacts and also a holding device for releasably holding at least a portion of the first and second mating contacts in the inner frame or a further inner frame includes the first and second mating contact element and also a further holding device for releasably holding at least a portion of the first and second contacts in the inner frame.

25. The system as recited in claim 24 wherein the outer frame includes an insertion device for receiving at least a portion of the first and second contacts or at least a portion of the first and second mating contacts.

26. The system as recited in claim 25 wherein the insertion device includes first and second cutouts and the holding device includes third and fourth cutouts.

27. The system as recited in claim 26 wherein the power tool connection apparatus includes a receiving region for receiving and releasably holding the battery connection apparatus, wherein the receiving region has a first length and the outer frame has a second length, and wherein the first length is equal to or greater than the second length, and wherein each of the first and second cutouts of the insertion device has a first width and each of the third and fourth cutouts of the holding device has a second width, and wherein the first width is equal to or greater than the second width, and wherein a difference between the first width and the second width is equal to or smaller than a difference between the first length and the second length.

28. The system as recited in claim 24 wherein the outer frame includes a guide for receiving and releasably holding at least a partial region of the inner frame in at least one direction (A).

29. The asystem as recited in claim 24 wherein the rechargeable battery is a power supply for the power tool.
